(19) United States
(12) Patent Application Publication
(10) Pub. No.: US 2017/0136498 A1
(43) Pub. Date: May 18, 2017

(54) CLASSIFIER

(71) Applicant: HOSOKAWA MICRON CORPORATION, Osaka (JP)

(72) Inventors: MASAHIRO INOKI, Osaka (JP); MASAHIRO YOSHIKAWA, Osaka (JP); TOMOYUKI CHIBA, Osaka (JP)

(73) Assignee: HOSOKAWA MICRON CORPORATION, Osaka (JP)

(21) Appl. No.: 15/129,565

(22) PCT Filed: Mar. 31, 2014
(86) PCT No.: PCT/JP2014/059519

§ 371 Date: Sep. 27, 2016

(51) Int. Cl. B07B 7/083

(52) U.S. Cl. CPC B07B 7/083

(57) ABSTRACT

Provided is a classifier capable of classifying smaller microparticles and obtaining a narrower particle size distribution. The classifier includes a classification rotor constituted of a cylindrical body having a plurality of classification blades in an outer circumference portion thereof and having also an opening portion that opens in one lateral face thereof along an axis of the cylindrical body, a device body that accommodates the classification rotor and holds the classification rotator rotatably about the axis and that introduces classification-target powder from the outside and feeds the powder to the outer circumference portion of the classification rotor, and a discharging portion for drawing the powder classified by the classification rotor and removing the power to the outside of the device body, wherein a rotational shaft portion extending from an open face of the constriction portion to the other lateral face of the classification rotor has a diameter that increases progressively toward the other lateral face.

### TECHNICAL FIELD

This disclosure relates to a classifier, more particular to a classifier for obtaining super-fine powder.

### BACKGROUND ART

In a classifier including a classification rotor constituted of a cylindrical body having a plurality of classification blades in an outer circumference portion thereof and having also an opening portion that opens in one lateral face thereof along an axis of the cylindrical body, a device body that accommodates the classification rotor and holds the classification rotator rotatably about the axis and that introduces classification-target powder from the outside and feeds the powder to the outer circumference portion of the classification rotor, and a discharging portion for drawing the powder to be classified by the classification rotor and removing the power to the outside of the device body, according to the convention, a leading end portion of the discharging portion disposed to enter the inside of the classification rotor is attached to the classification rotor to be rotatable in unison therewith, thus reducing a relative speed difference between powder passing in whirl-round motion at the leading end portion and the inner wall of the leading end portion, so that frictional wear of the inner wall of the leading end portion and adherence of powder thereto can be reduced (see Patent Document 1).

Further in the classifier of the above-noted type, there has also been proposed a classifier configured as follows. Namely, the leading end portion of the discharging portion is formed with an approximately tapered shape whose aperture diameter progressively increases from the leading end side toward the discharging side, thus decreasing an angle of impact between the powder passing through the leading end portion and the wall face of the leading end portion, so that the impact received by the inner wall of the leading end portion from the powder and friction between the inner wall and the powder are reduced (see e.g. Patent Document 2).

### PRIOR ART DOCUMENTS

### Patent Documents

Patent Document 1: Japanese Unexamined Patent Application Publication No. 2002-355612
Patent Document 2: Japanese Unexamined Patent Application Publication No. 2006-212538

### SUMMARY

### Problem to be Solved by Invention

In recent years, however, there has been a demand for an even higher classification performance for the above-described conventional classifier.

The present invention has been made in view of the above and its object is to provide a classifier capable of classifying smaller microparticles and obtaining a narrower particle size distribution.

### Solution

According to a characterizing feature of a classifier relating to the present invention, the classifier comprises a classification rotor constituted of a cylindrical body having a plurality of classification blades in an outer circumference portion thereof and having also an opening portion that opens in one lateral face thereof along an axis of the cylindrical body, a constriction portion provided in the opening portion and reducing its inside diameter, a device body that accommodates the classification rotor and holds the classification rotator rotatably about the axis and that introduces classification-target powder from the outside and feeds the powder to the outer circumference portion of the classification rotor, and a discharging portion for drawing the powder classified by the classification rotor and removing the power to the outside of the device body, wherein a rotational shaft portion extending from an open face of the constriction portion to the other lateral face of the classification rotor has a diameter that increases progressively toward the other lateral face.

According to the classifier having the above-described feature, in addition to the conventional classification by the classification blades, as a rotational shaft portion extending from an open face of the constriction portion to the other lateral face of the classification rotor has a diameter that increases progressively toward the other lateral face, a flow rate of semifree vortex generated inside the classification rotor is increased to be discharged from the classification rotor, further classification is made possible, whereby the classification accuracy can be improved.

According to a further characterizing feature of the present invention, the constriction portion is formed to be progressively decreased in its diameter from the opening portion of the classification rotor to the inside of the classification rotor.

With the above-described arrangement, since the leading end of the constriction portion enters the inside of the classification rotor, the difference of distance (or the distance) from the respective part of the classification blades to the opening face can be reduced. Therefore, the flow state of air inside the classification rotor can be rendered uniform, thus enhancing the classification accuracy.

Further, at the time of discharge from the classification rotor, as the angle of impact between the powder passing through the constriction portion and the wall face of the constriction face is decreased, friction between the powder and the constriction portion can be reduced, so that deceleration in the flow rate of the semifree vortex can be prevented.

According to a still further characterizing feature of the present invention, a ratio of an effective passage cross sectional area of the classified powder in the opening face relative to an inner cross sectional of the classification rotor is set to be 10% or less.

Incidentally, in the context of the present invention, the language “an effective passage cross sectional area of the powder” refers to an area in the opening face that the classified powder can pass; and the language “an inner cross sectional of the classification rotor” refers to a cross sectional area in the classification rotor including the rotational shaft portion.

With the above-described arrangement, it is possible to effectively accelerate the flow rate of the semifree vortex passing through the opening face. As a result, it is possible to lower the cutting point of classification and also to make the particle size distribution smaller, so that the classification accuracy can be further enhanced.

According to a still further characterizing feature of the present invention, a ratio of the cross sectional area of the rotational shaft portion in the opening face relative to the cross sectional area of the opening face is set to be 30% or more.

With the above-described arrangement, it is possible to increase the rotational speed of the classification rotor by the increase of the cross sectional area of the rotational shaft portion, so that the classification accuracy can be further improved.

According to a still further characterizing feature of the present invention, the classification rotor is formed of silicon nitride ceramics.

With the above-described arrangement, it is possible to reduce the weight of the classification rotor by the use of silicon nitride ceramics. So that, the rotational speed of the classification rotor can be increased. As a result, the classification accuracy is improved. Further, since silicon nitride ceramics has a high hardness, it is possible to provide the classification rotor with superior friction resistance property.

### BRIEF DESCRIPTION OF THE DRAWINGS

FIG. 1 is a section view along an axial direction showing schematically a principal configuration of a classifier 1 according to one embodiment of the present invention,

FIG. 2 is a section view along an axial direction showing schematically a classification rotor 3 according to one embodiment of the present invention,

FIG. 3 is a top plan view showing schematically a classification rotor 3 according to one embodiment of the present invention,

FIG. 4 shows a particle size distribution of raw-material powder used in example of the invention and comparison example,

FIG. 5 shows a particle size distribution of fine particles obtained when the inventive classifier 1 was used,

FIG. 6 shows a particle size distribution of fine particles obtained when a classifier 1′ of comparison example of the invention was used,

FIG. 7 shows a particle size distribution of fine particles obtained when the inventive classifier 1 was used,

FIG. 8 shows one variation of a rotational shaft portion 2 in the inventive classifier 1, and

FIG. 9 shows one variation of the rotational shaft portion 2 in the inventive classifier 1.

### EMBODIMENTS

Next, with reference to the drawings, a classifier 1 according to one embodiment of the present invention will be explained.

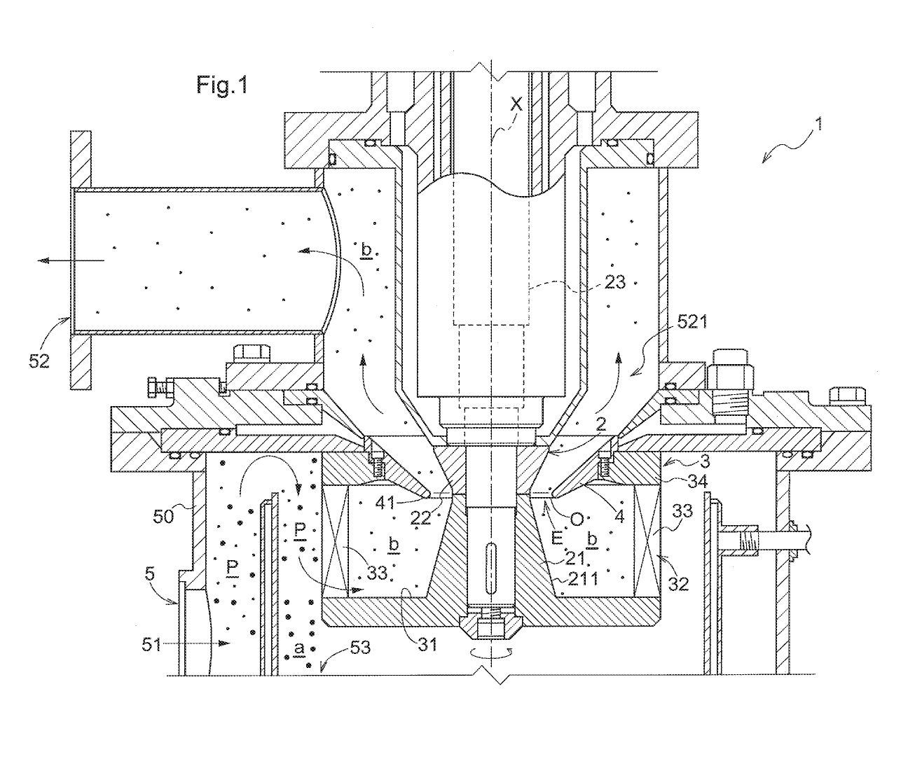

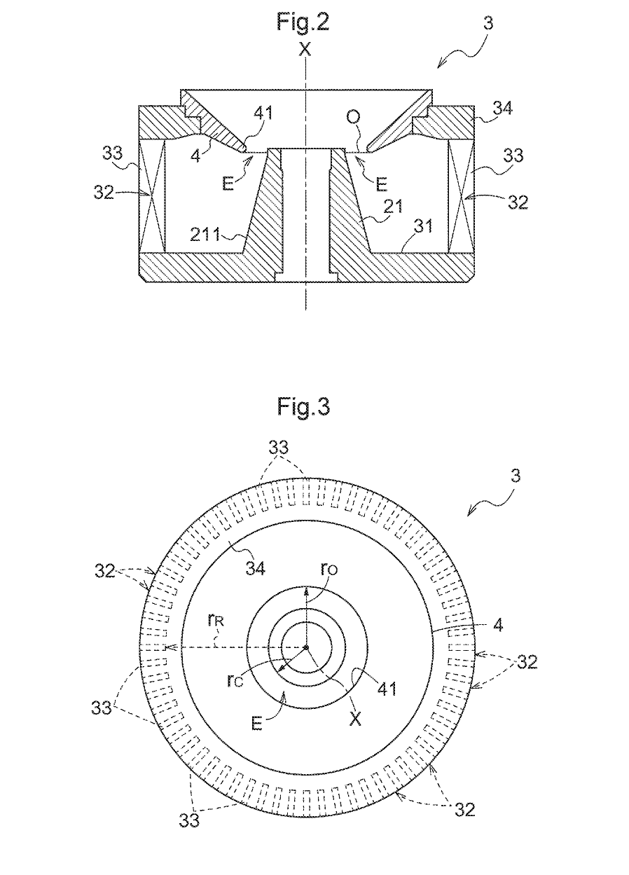

FIG. 1 is a vertical section view along an axial direction showing schematically a principal configuration of the classifier 1 according to one embodiment of the present invention. FIG. 2 is a section view along an axial direction showing schematically a classification rotor 3. FIG. 3 is a top plan view showing schematically a classification rotor 3.

The classifier 1 includes a classification rotor 3, a device body 5 that accommodates the classification rotor 3 and holds the classification rotator 3 rotatably about an axis X and that introduces raw-material powder P as “classification-target powder” from the outside and feeds the powder to an outer circumference portion of the classification rotor 3, and a discharging portion 52 for drawing the fine powder (b) classified by the classification rotor 3 and removing the power (b) to the outside of the device body 5.

The classification rotor 3 is constituted of a cylindrical body having a plurality of classification blades 33 in an outer circumference portion thereof and is rotatable about an axis X. In the classification rotor 3, there is provided an opening portion 34 that opens in one lateral face thereof in the direction along the axis X.

The classification blades 33 are disposed by a predetermined spacing along the radial direction of the cylindrical body in such a manner to project toward the axis X. In operation, in association with rotation of the classification rotor 3, the classification blades 33 generate forcible vortex about the classification rotor 3. Also, via gaps 32 formed between the respective adjacent classification blades 33, powder and air can flow into the classification rotor 3.

At the opening portion 34 of the classification rotor 3, there is provided a dip pipe 4 acting as a “constriction portion” for reducing its inside diameter. The dip pipe 4 has an approximately tapered shape whose diameter progressively decreases from the opening portion 34 to the inner side of the classification rotor 3 and a leading end portion 41 thereof constitutes an opening face O.

The rotational shaft portion 2 includes a first shaft portion 21 and a second shaft portion 22 provided in this order from the lower side in FIG. 1 and the rotational shaft portion 2 is configured to be rotatable together with the classification rotor 3 about the axis X by a shaft 23 as a drive shaft of the classification rotor 3 whose upper end portion is coupled to a drive means (not shown).

The first shaft portion 21 is formed integral with the classification rotor 3 and allows extension of the shaft 23 therethrough. And, the first shaft portion 21 is coupled to be rotatable with the shaft 23 in the lower face of the classification rotor 3. The first shaft portion 21 has an approximately truncated cone shape whose diameter progressively decreases from a bottom face 31 which is “the other lateral face” of the classification rotor 3 along the opening face O of the dip pipe 4. This first shaft portion 21 and a leading end portion 41 of the dip pipe 4 together form a passage face E through which the powder (b) passes toward the discharging portion 52.

Relative to the first shaft portion 21, the second shaft portion 22 has an invert truncated cone shape whose diameter progressively increases upwards from the opening face O of the classification rotor 3. With this, the second shaft portion 22 and a cover of the shaft 23 can together form a discharge passage 521 having less step difference. As a result, it is possible to reduce resistance against air flow in the discharge passage 521 and also to prevent adhesion of powder into the discharge passage 521 and intrusion of dust into the shaft. Similarly to the first shaft portion 21, the second shaft portion 22 allows extension of the shaft 23 therethrough and can be rotated together with the shaft 23 and the first shaft portion 21.

As a material for forming the classification rotor 3, a standard steel material, alumina, zirconia, silicon nitride ceramics, etc. can be used. In particular, if silicon nitride ceramics is used, thanks to its light weight and high strength, the classification rotor 3 can be formed light weight and its rotational speed can be further increased.

The device body 5 includes a casing 50 accommodating the classification rotor 3, a raw material feeding portion 51 for feeding the raw material powder P and a coarse powder discharging portion 53 for discharging coarse powder (a) whose entrance into the classification rotor 3 has been prevented by the classification blades 33 of the classification rotor 3.

Incidentally, FIG. 1 shows only the portion where the classification rotor 3 is provided, mainly, with illustration of the other portions being omitted. Alternatively, however, the inventive classifier can be configured as a device having only the classifier function or as a device having other functions as well. For instance, the inventive classifier can be provided as a part of a pulverizing machine, so that a pulverization treatment and a classification treatment of powder can be effected continuously.

The discharging portion 52 has the discharge passage 521 and sucks air inside the classification rotor 3 through the discharge passage 521 by a suction means such as a blower (not shown), with the force of suction being variable. For instance, the rotational speed of a suction fan can be changed or an amount of air to be sucked can be varied appropriately by a flow amount adjusting valve or the like.

With the classifier 1 described above, the classification rotor 3 can be rotated at a high speed by a drive means and air inside the classification rotor 3 can be sucked by the suction means. And, air present in the outer circumference of the classification rotor 3 can be drawn in through the gaps 32 of the classification rotor 3 which is being rotated at a high speed. With this, fine powder (b) whose particle sizes are blow a predetermined particle size will be drawn into the classification rotor 3. Whereas, coarse powder (a) having larger particle sizes will be prevented from flowing into the classification rotor 3 by the rotated classification blades 33. As a result, a first stage of classification can be effected here.

Air introduced in the classification rotor 3 together with the fine powder (b) will be rendered by the high-speed rotation of the classification rotor 3 into semifree vortex inside the classification rotor 3 and will rise and pass the passage face E. Under the effect of centrifugal force of this semifree vortex, some of the fine powder (b) drawn into the classification rotor 3 which has a relatively large particle size will be thrown away to the outer side, whereby a solid-gas ratio (contained dust concentration) inside the semifree vortex is reduced, which allows passage of only fine powder (b) having even smaller particle size through the passage face E, so that a second stage of classification is effected here.

In the above, the outside diameter of the first shaft portion 21 in the passage face E is reduced so as to cause the passage to take place from more center side of the semifree vortex through the passage face E and also the area of the passage area E is reduced by the drip pipe 4 to increase the flow rate passing through the passage face E. As a result, only the fine powder (b) having even smaller particle size is allowed to pass the passage face E, so that the classification accuracy is even further enhanced.

Also, the first shaft portion 21 is formed like a truncated cone to render an angle formed between an outer circumferential face 211 of the first shaft portion 21 and the bottom face portion 31 of the classification rotor 3 into an obtuse angle. This arrangement makes it more difficult for the air introduced into the classification rotor 3 to be stagnated between the first shaft portion 21 and the bottom face portion 31. As a result, reduction of flow rate due to resistance against the semifree vortex can be prevented.

Moreover, as the dip pipe 4 is provided to be rotatable together with the classification rotor 3, frictional wear between the air inside the classification rotor 3 and the dip pipe 4 is prevented and reduction of flow rate of the semifree vortex can be avoided. Furthermore, in the course of the above, if the dip pipe 4 is caused to advance into the classification rotor 3, it is possible to reduce possible differences of distance from the respective parts of the classification blades 33 to the passage face E, so that the flow state of air inside the classification rotor 3 can be rendered uniform.

Incidentally, the fine powder (b) classified by the classification rotor 3 will be discharged by the discharging portion 52 and then guided to a collecting means such as a bag filter or the like, so that it will be taken out as a product.

### EXAMPLES

Next, examples of using the classifier relating to the present invention will be shown and the present invention will be explained in greater details. It is understood however that the present invention is not limited to these examples.

With the classifier 1 relating to the embodiment, studies were made on a ratio (Ratio A) of a fine powder effective passage cross sectional area (S_{E}) in the opening face O relative to an inner cross sectional area (S_{R}) of the classification rotor 3, a ratio (Ratio B) of a cross sectional area (S_{C}) of the first shaft portion 21 in the opening face O relative to a cross sectional area (S_{O}) of the opening face O and fine powder particle size distribution obtained thereby. Further, as Comparison Example, studies were made similarly on Ratio A, Ratio B and the fine powder particle size distribution obtained thereby when using a classifier 1′ not having the inventive rotational shaft portion 2 in which the classification rotor 3 is directly supported to the shaft 23.

The methods of calculating Ratio A and Ratio B are as shown by the following mathematical Formula 1 and Formula 2. As shown in FIG. 3, r_{O} is a distance from the axis X to the leading end portion 41 of the dip pipe 4, r_{C} is a radius of the rotational shaft portion 2 in the opening face O, and r_{R} is a radius of the inside cross section of the classification rotor 3 (distance from the axis X to the inner side of the classification blade 33).

$$\begin{matrix}Ratio A = \frac{powder effective passage cross sectional area \text{:} {S}_{E}}{inner cross sectional area of classification rotor 3 \text{:} {S}_{R}} = \frac{π {r}_{O}^{2} - π {r}_{C}^{2}}{π {r}_{R}^{2}} & [ Formula 1 ] \\ Ratio B = \frac{cross sectional area of rotational shaft portion 2 in opening face O \text{:} {S}_{C}}{cross sectional area of opening face \text{:} {S}_{O}} = \frac{π {r}_{C}^{2}}{π {r}_{O}^{2}} & [ Formula 2 ]\end{matrix}$$

The respective sizes and proportions of the classifier 1, 1′ used respectively in the Examples and Comparison Example are as shown in Table 1 below.

TABLE 1

| | rotor inner | opening | cross sectional area | | | |
|---|---|---|---|---|---|---|
| | cross | cross | of rotational shaft | effective passage | | |
| | sectional | sectional | portion 2 in | cross sectional | | |
| | area | area | opening face | area | Ratio A = | Ratio B = |
| | S_{R} | S_{O} | S_{C} | S_{E} | S_{E}/S_{R} | S_{C}/S_{O} |
| | (mm²) | (mm²) | (mm²) | (mm²) | (%) | (%) |
| Example | 53066 | 7085 | 2123 | 4962 | 9.4 | 30.0 |
| Comparison | 49063 | 7085 | 113 | 6972 | 14.2 | 1.6 |
| Example | | | | | | |

### Example 1

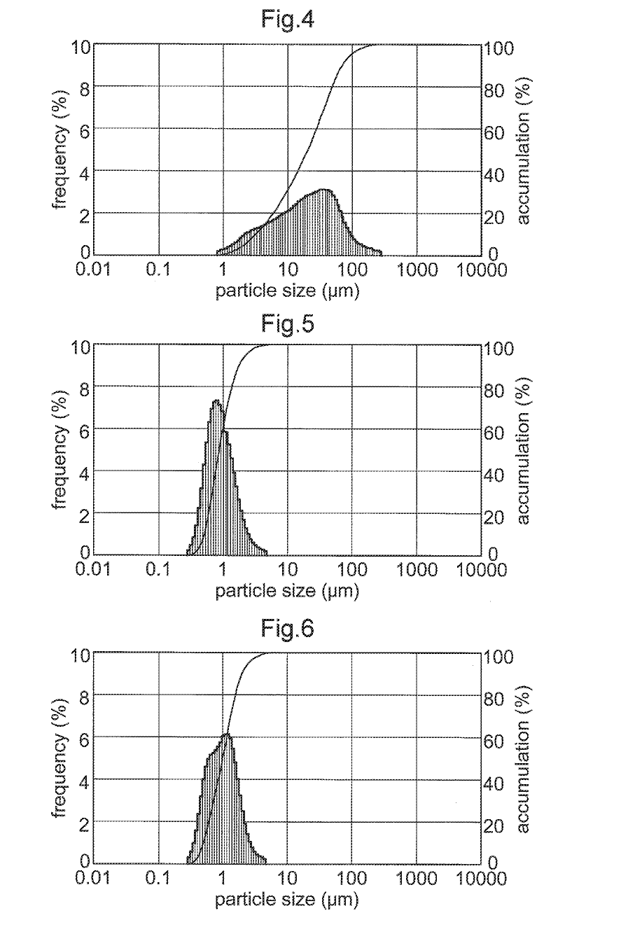

FIG. 5 and Table 2 show particle size distribution in which classification was effected with using raw material powder having the particle size distribution shown in FIG. 4 by operating the classifier 1 under the conditions of: operational air amount 7.0 m³/min; processing capacity: 6.4 kg/h. In this, a top size cutting (D90/50) was: 1.437 (μm)/0.726 (μm)=2.0

TABLE 2

| accumulation (%) | particle size (μm) |
|---|---|
| 10.00 | 0.425 |
| 20.00 | 0.502 |
| 30.00 | 0.571 |
| 40.00 | 0.643 |
| 50.00 | 0.726 |
| 60.00 | 0.824 |
| 70.00 | 0.948 |
| 80.00 | 1.124 |
| 90.00 | 1.437 |
| 95.00 | 1.792 |

### Comparison Example

FIG. 6 and Table 3 show particle size distribution in Comparison Example in which classification was effected with using same raw material powder used in Example by operating the classifier 1′ as Comparison Example under the conditions of: operational air amount 7.0 m³/min; processing capacity: 7.7 kg/h. In this, D90/50 was: 1.892 (μm)/0.982 (μm)=1.9

It was found that with the classifier 1 of Example, smaller particle sizes were obtained in comparison with the classifier 1′ of Comparison Example.

TABLE 3

| accumulation (%) | particle size (μm) |
|---|---|
| 10.00 | 0.501 |
| 20.00 | 0.607 |
| 30.00 | 0.718 |
| 40.00 | 0.844 |
| 50.00 | 0.982 |
| 60.00 | 1.133 |
| 70.00 | 1.305 |
| 80.00 | 1.526 |
| 90.00 | 1.892 |
| 95.00 | 2.279 |

### Example 2

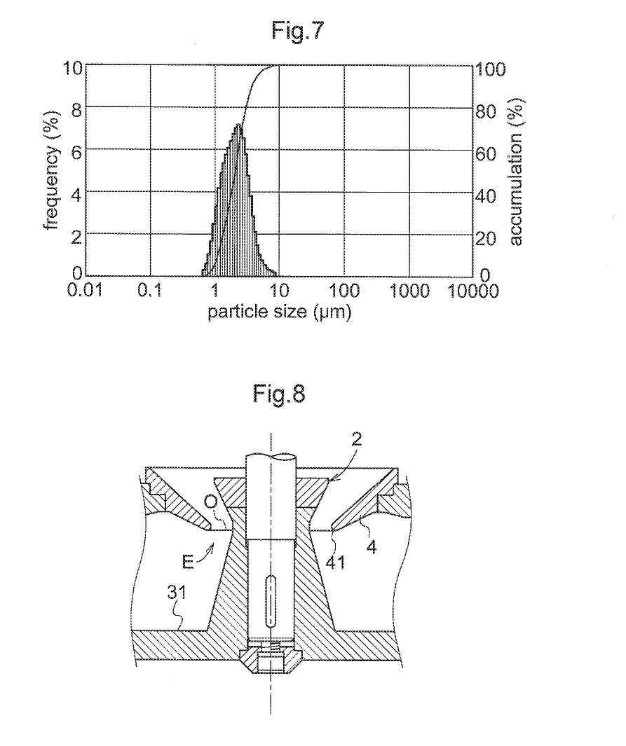

With using the classifier 1 and for obtaining similar particle size to that of Comparison Example, classification was effected under operational conditions of: operational air amount 7.0 m³/min; processing capacity: 8.7 kg/h, resultant particle distribution being shown in FIG. 7 and Table 4 below. In this, D90/50 was: 1.615 (μm)/0.908 (μm)=1.8. It was found that sharper particle size distribution than Comparison Example can be obtained.

TABLE 4

| accumulation (%) | particle size (μm) |
|---|---|
| 10.00 | 0.494 |
| 20.00 | 0.595 |
| 30.00 | 0.695 |
| 40.00 | 0.799 |
| 50.00 | 0.908 |
| 60.00 | 1.026 |
| 70.00 | 1.160 |
| 80.00 | 1.333 |
| 90.00 | 1.615 |
| 95.00 | 1.912 |

Classifications were effected with using classifiers 1 (a) and (b) which were prepared by changing size and ratio in the classifier 1 of Example as shown in Table 5. As a result, similar results to Example were obtained.

TABLE 5

| | rotor inner | opening | cross sectional area | | | |
|---|---|---|---|---|---|---|
| | cross | cross | of rotational shaft | effective passage | | |
| | sectional | sectional | portion 2 in | cross sectional | | |
| | area | area | opening face | area | Ratio A = | Ratio B = |
| | S_{R} | S_{O} | S_{C} | S_{E} | S_{E}/S_{R} | S_{C}/S_{O} |
| | (mm²) | (mm²) | (mm²) | (mm²) | (%) | (%) |
| Classifier 1 | 107467 | 14307 | 5024 | 9283 | 8.6 | 35.1 |
| (a) | | | | | | |
| Classifier 1 | 17663 | 2826 | 1256 | 1570 | 8.9 | 44.4 |
| (b) | | | | | | |

In all the cases using the classifier 1 of Example, the classification accuracies were high.

Further, classifications were effected with using classifiers 1′ (a)-(c) which were prepared by changing size and ratio in the classifier 1′ of Comparison Example as shown in Table 6. As a result, similar results to Comparison Example were obtained.

TABLE 6

| | rotor inner | opening | cross sectional area | | | |
|---|---|---|---|---|---|---|
| | cross | cross | of rotational shaft | effective passage | | |
| | sectional | sectional | portion 2 in | cross sectional | | |
| | area | area | opening face | area | Ratio A = | Ratio B = |
| | S_{R} | S_{O} | S_{C} | S_{E} | S_{E}/S_{R} | S_{C}/S_{O} |
| | (mm²) | (mm²) | (mm²) | (mm²) | (%) | (%) |
| Classifier 1′ | 49063 | 5672 | 113 | 5559 | 11.3 | 2.0 |
| (a) | | | | | | |
| Classifier 1′ | 49063 | 7085 | 707 | 6378 | 13.0 | 10.0 |
| (b) | | | | | | |
| Classifier 1′ | 49063 | 5672 | 707 | 4965 | 10.1 | 12.5 |
| (c) | | | | | | |

As described above, in comparison with the conventional classifier, the classier 1 relating to the embodiment can decrease particle size of fine powder obtained by classification and also make particle size distribution sharper.

That is, it was found that for the classifier 1, Ratio A is preferably 10% or lower, more preferably from 8.6% to 9.4% and Ratio B is preferably 30% or more, more preferably from 30.0% to 44.4%.

### Other Embodiments

In the foregoing embodiment, there was shown a case in which the first shaft portion 21 and the second shaft portion 22, in the rotational shaft portion 2, are formed of separate members. Instead, the first shaft portion 21 and the second shaft portion 22 can be formed integral with each other.

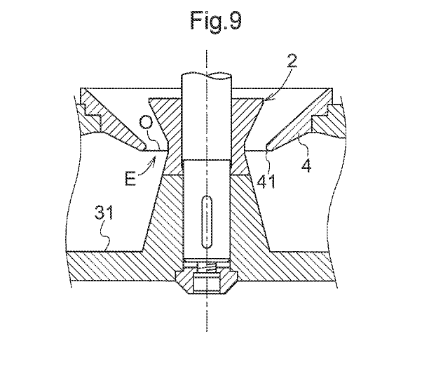

Further, in the foregoing embodiment, there was shown a case in which the first shaft portion 21 and the second shaft portion 22 are connected to each other in the opening face O. Instead, as shown in FIG. 8 and FIG. 9, they can be connected to each other upwardly or downwardly of the opening face O.

In the foregoing embodiment, the first shaft portion 21 is formed integral with the classification rotor 3. Alternatively, in the present invention, it may be formed separately from the classification rotor 3.

In the foregoing embodiment, there was shown a case in which the second shaft portion 22 has its outer circumferential face portion 211 having a diameter which progressively increases upwards. However, the shape of the second shaft portion 22 is not limited.

In the foregoing embodiment, there was shown a case in which the rotational shaft portion 2 allows extension therethrough of the shaft 23 connected to the drive means and is connected in the lower face of the classification rotor 3. However, what is required is only rotatability of the classification rotor 3. The shape, arrangement, connecting mode, etc. of the shaft 23 are not limited.

In the foregoing embodiment, there was shown a case having the classification blades 33 in the form of flat plates. Alternatively, these classification blades 33 can have a predetermined angle relative to the axis X or can be mounted obliquely relative to the radial direction. Further, the classification blades 33 can have an inclined shape or curved shape.

### DESCRIPTION OF REFERENCE MARKS/NUMERALS

1: classifier
2: rotational shaft portion
21: first shaft portion
211: outer circumferential face portion (first shaft portion)
22: second shaft portion
23: shaft
3: classification rotor
31: bottom face portion
32: gap
33: classification blade
34: opening portion
4: dip pipe (constriction portion)
41: leading end portion
5: device body
50: casing
51: raw material feeding portion
52: discharging portion
521: discharge passage
53: coarse powder discharging portion
X: axis
O: opening face
E: passage face
P: raw material powder
a: coarse powder
b: fine powder

1. A classifier comprising:
a classification rotor constituted of a cylindrical body having a plurality of classification blades in an outer circumference portion thereof and having also an opening portion that opens in one lateral face thereof along an axis of the cylindrical body;
a constriction portion provided in the opening portion and reducing its inside diameter;
a device body that accommodates the classification rotor and holds the classification rotator rotatably about the axis and that introduces classification-target powder from the outside and feeds the powder to the outer circumference portion of the classification rotor; and
a discharging portion for drawing the powder classified by the classification rotor and removing the power to the outside of the device body;
wherein a rotational shaft portion extending from an open face of the constriction portion to the other lateral face of the classification rotor has a diameter that increases progressively toward the other lateral face.

2. The classifier according to claim 1, wherein the constriction portion is formed to be progressively decreased in its diameter from the opening portion of the classification rotor to the inside of the classification rotor.

3. The classifier according to claim 1, wherein a ratio of an effective passage cross sectional area of the classified powder in the opening face relative to an inner cross sectional of the classification rotor is set to be 10% or less.

4. The classifier according to claim 1, wherein a ratio of the cross sectional area of the rotational shaft portion in the opening face relative to the cross sectional area of the opening face is set to be 30% or more.

5. The classifier according to claim 1, wherein the classification rotor is formed of silicon nitride ceramics.
